(19) United States
(12) Patent Application Publication
(10) Pub. No.: US 2011/0200216 A1
(43) Pub. Date: Aug. 18, 2011

(54) FITTING SYSTEM OF DIGITAL HEARING AID TO BE CAPABLE OF CHANGING FREQUENCY BAND AND CHANNEL

(76) Inventors: Sang-Min Lee, Incheon (KR); Hey-Mi Lee, Incheon (KR)

(21) Appl. No.: 13/124,563

(22) PCT Filed: Oct. 22, 2008
(86) PCT No.: PCT/KR2008/006244

§ 371 Date: Apr. 15, 2011

(30) Foreign Application Priority Data
Oct. 16, 2008 (KR) 1020080101493

(51) Int. Cl. H04R 25/00

(52) U.S. Cl. 381/314

(57) ABSTRACT

Disclosed is a digital hearing aid fitting system capable of changing a frequency band and channel. The digital hearing aid fitting system capable of changing the frequency band and channel may include a digital signal processing (DSP) chip to adjust a fitting parameter including at least one parameter from among a number of bands of a frequency, a bandwidth, and a number of channels of the frequency, and a controlling unit to control the DSP chip based on a hearing test result to adjust the fitting parameter to a person with hearing loss.

### TECHNICAL FIELD

The example embodiments of the present invention relates to a digital hearing aid fitting system capable of changing a frequency band and a channel.

### BACKGROUND ART

An increasing aging population due to development of modern medical science and hearing loss of the younger generation has rapidly increased due to an increase of a noisy environment, and thus, demand for a hearing aid that is an essential daily necessity to a person with hearing loss continuously increases.

Accordingly, the hearing aid, such as an analog hearing aid, an analog/digital mixed hearing aid, and a digital hearing aid, has been widely developed. The digital hearing aid type of the hearing aids has been popular for persons with hearing loss since adjusting output characteristics and performing fitting of the digital hearing aid is simple, compared with the analog hearing aid.

However, a conventional digital hearing aid requires setting of a digital signal processing (DSP) chip to be performed according to a design and model of the digital hearing aid even though the same DSP chip of each hearing aid company is used. Therefore, a bandwidth, a number of frequency bands, and a number of channels through which hearing is compensated are fixed, and also a fitting parameter to be fitted is different.

That is, since a conventional fitting program provides a different menu for each hearing aid model, the person with hearing loss needs to have a hearing test and to select an appropriate digital hearing aid. In this instance, the menu is a collection of functions to help in setting up a hearing aid model with respect to a fitting parameter preset for each hearing aid model.

Therefore, the hearing aid is fitted according to the determined bandwidth using a fixed number of bands and channels of a corresponding hearing aid, and thus, the hearing aid is not appropriately fitted to the person with hearing loss.

Also, a hearing aid providing a great number of bands and channels is expensive. If a hearing characteristic of the person with hearing loss does not need the hearing aid providing a great number of bands and channels, it may be wasteful.

Also, after purchasing a hearing aid, when the person with hearing loss later needs a hearing aid providing a far greater number of bands and channels than available with the purchased hearing aid, a new hearing aid is required, and thus the existing hearing aid may be returned or thrown away.

Accordingly, a digital hearing aid fitting system which enables a person using a hearing aid to select desired functions of the hearing aid and compensates for hearing loss according to a hearing characteristic of the person is required.

### DISCLOSURE OF INVENTION

### Technical Goals

An aspect of the present invention provides a digital hearing aid fitting system that determines a number of frequency bands, a bandwidth, and a number of frequency channels optimal to a person with hearing loss through using a fitting program capable of adjusting a fitting parameter of the same digital signal processing (DSP) chip regardless of a design or a model of a digital hearing aid.

An aspect of the present invention provides a digital hearing aid fitting system that appropriately compensates for hearing loss according to a characteristic of the hearing loss, the characteristic being variable, through using a fitting program capable of adjusting a fitting parameter using the same DSP chip regardless of a design or a model of a digital hearing aid.

### Technical Solutions

According to an aspect of the present invention, there is provided a digital hearing aid fitting system capable of changing a frequency band and a channel, the system including a digital signal processing (DSP) chip to adjust a fitting parameter including at least one parameter from among a number of bands of a frequency, bandwidth, and a number of channels of the frequency, and a controlling unit to control the DSP chip based on a hearing test result to adjust the fitting parameter to a person with hearing loss.

According to an aspect of the present invention, there is provided a digital hearing aid fitting system capable of changing a frequency band and a channel, the system including a fitting parameter selecting unit to select a fitting parameter appropriate to a person with hearing loss based on a hearing test result, a parameter displaying unit to display the fitting parameter selected from the fitting parameter selecting unit based on the hearing test result, and an adjusting unit to control a DSP chip to adjust a fitting parameter to the fitting parameter selected from the fitting parameter selecting unit.

### ADVANTAGEOUS EFFECT

According to the present invention, a number of frequency bands, a bandwidth, and a number of frequency channels optimal to a person with hearing loss may be determined through using a fitting program capable of adjusting a fitting parameter of the same digital signal processing (DSP) chip regardless of a design or a model of a digital hearing aid.

According to the present invention, hearing loss may be appropriately compensated for according to a characteristic of the hearing loss, the characteristic being variable, through using a fitting program capable of adjusting a fitting parameter of the same DSP chip regardless of a design or a model of a digital hearing aid.

### BRIEF DESCRIPTION OF DRAWINGS

FIG. 1 is a diagram illustrating a digital hearing aid fitting system capable of changing a frequency band and channel according to an example embodiment of the present invention;

FIG. 2 is an example of a hearing test result used in a system performing a fitting program according to an example embodiment of the present invention;

FIG. 3 is an example of a fitting parameter adjusted based on the hearing test result of FIG. 2;

FIG. 4 is another example of a fitting parameter adjusted based on the hearing test result of FIG. 3; and

FIG. 5 is an example of a screen displayed from a parameter displaying unit according to an example embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

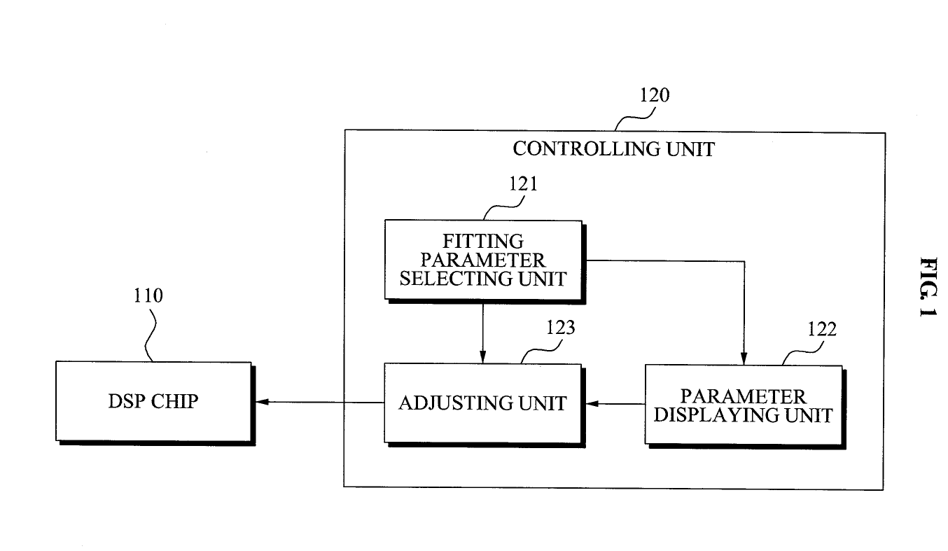

FIG. 1 is a diagram illustrating a digital hearing aid fitting system capable of changing a frequency band and channel according an example embodiment of the present invention.

Referring to FIG. 1, the digital hearing aid fitting system capable of changing the frequency band and channel includes a digital signal processing (DSP) chip 110 and a controlling unit 120. The DSP chip 110 is capable of adjusting a fitting parameter including at least one parameter from among a number of bands of a frequency, a bandwidth of the band, and a number of channels of the frequency. The controlling unit 120 controls the DSP chip based on a hearing test result and adjusts the fitting parameter to be appropriate to a person with hearing loss.

The fitting parameter may include at least one parameter from among the number of bands of the frequency, the bandwidth of the band, and the number of channels of the frequency.

In this instance, the DSP chip 110 may change the bandwidth and the number of bands and channels in any design or model of a hearing aid.

Also, a menu provided for adjusting the fitting parameter may not be affected by the design or model of the hearing aid, the menu being provided by a fitting program which is set up in the controlling unit 120 to control the DSP chip 110.

As illustrated in FIG. 1, the fitting program may include a fitting parameter selecting unit 121 to select a fitting parameter appropriate to a person with hearing loss based on a hearing test result, a parameter displaying unit 122 to display the fitting parameter selected from the fitting parameter selecting unit based on the hearing test result, and an adjusting unit to control the DSP chip to adjust a fitting parameter to the fitting parameter selected from the fitting parameter selecting unit.

Also, the fitting program may be a program compatible with all digital hearing aid models combined with the DSP chip that adjusts the fitting parameter.

In this instance, the adjusting unit 123 may include a number of frequency bands selecting unit for selecting a number of bands of a frequency, a bandwidth selecting unit for selecting a bandwidth, and a number of channels selecting unit for selecting a number of channels to provide most appropriate fitting to the person with hearing loss.

Also, when the fitting parameter selecting unit 121 selects examples of a fitting parameter selectable to the person with hearing loss based on the hearing test result, the fitting program may display the examples on the parameter displaying unit 122 to be selected by the person with hearing loss. In this instance, when at least one example from among the examples displayed on the parameter displaying unit 122 is selected, the adjusting unit 123 may control the DSP chip 110 to adjust the fitting parameter to the selected example.

Also, when the fitting parameter selecting unit 121 selects the fitting parameter appropriate to the person with hearing loss based on the hearing test result, the fitting program may control the DSP chip 110 via the adjusting unit 123 and adjust the fitting parameter to correspond to the selected fitting parameter. In this instance, the parameter displaying unit 122 may display the hearing test result and a fitting result of the person with hearing loss.

Also, the fitting program may further include an amplification degree adjusting unit and an automatic gain control (AGC) adjusting unit according to a band and a channel predetermined in a digital hearing aid fitting system capable of changing the frequency band and channel, and other units to provide feedback cancellation or noise cancellation function for each kind of hearing aid according to a hearing aid company or the hearing aid.

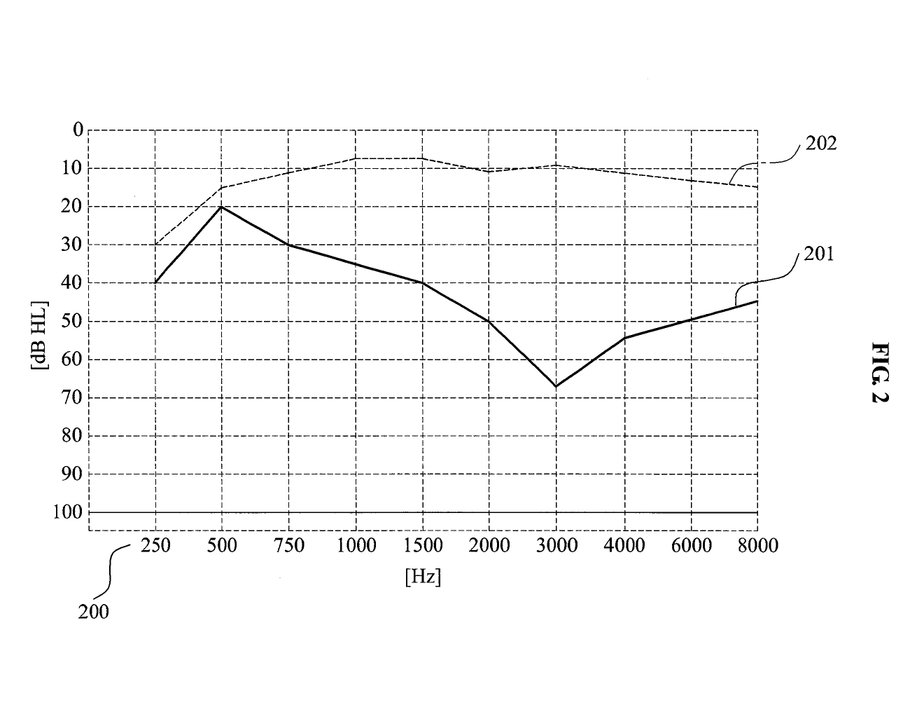

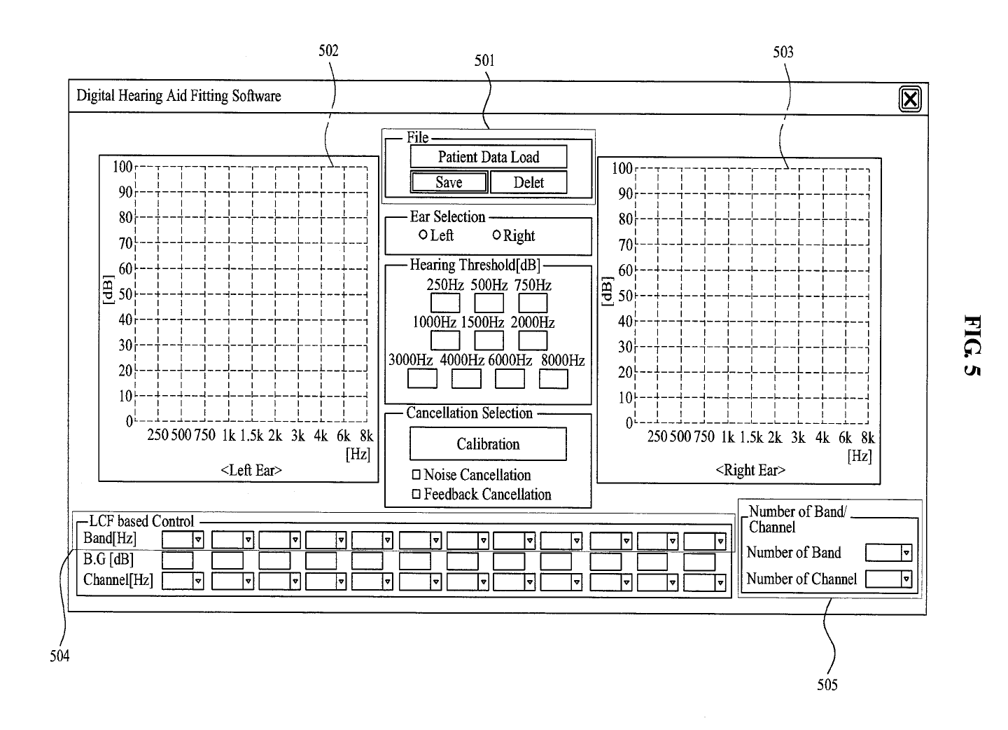

An operation of the digital hearing aid fitting system capable of changing the frequency band and channel will be described in detail referring to FIGS. 2 and 5.

FIG. 2 is an example of a hearing test result used in a system performing a fitting program according to an example embodiment of the present invention.

As illustrated in FIG. 2, the fitting program according to the present invention may perform fitting based on the hearing test result 200 in which a scope of a center frequency is departmentalized segmented. In this instance, a hearing test result 201 of a person with hearing loss who may need the digital hearing aid capable of changing the frequency band and channel shows that a specific frequency band is recorded in a lower dB hearing level (dBHL), compared with a hearing test result of a normal person.

The fitting program according to the present invention may change a number of frequency bands, a bandwidth, and a number of channels based on the hearing test result 201 of the person with hearing loss.

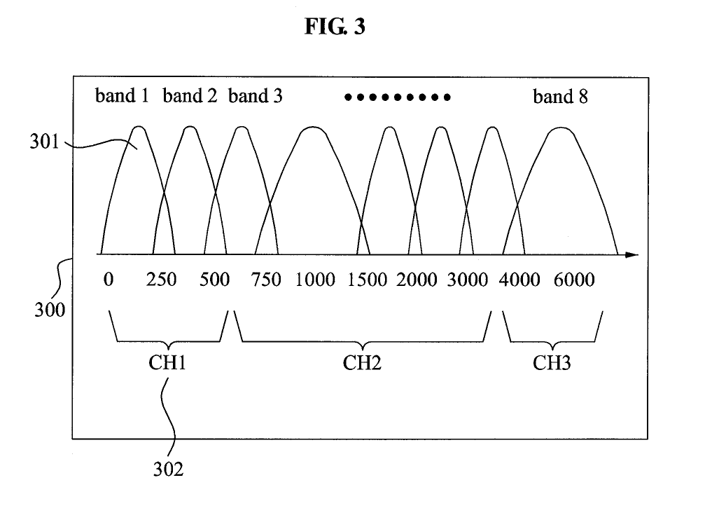

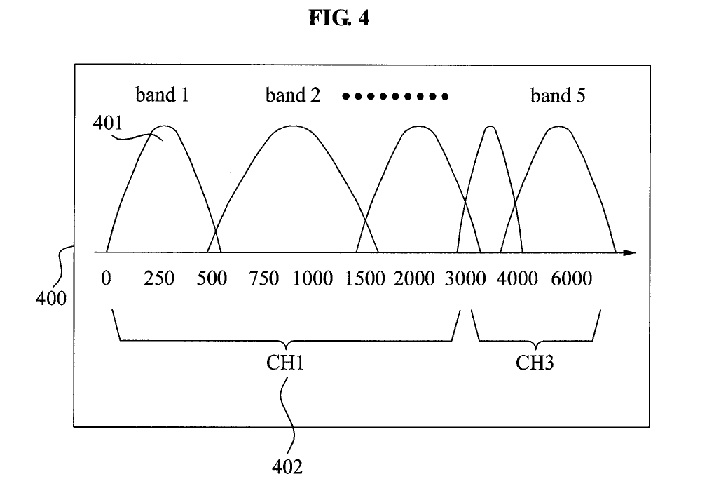

FIG. 3 is an example of a fitting parameter adjusted based on the hearing test result of FIG. 2 and FIG. 4 is another example of a fitting parameter adjusted based on the hearing test result of FIG. 3.

For an example, in the case when the hearing test result 200 is the same as the hearing test result 201 of the person with hearing loss, a conventional hearing aid enables the person to select one hearing aid from among hearing aids in which bands and channels are set as eight bands and four channels through twelve bands and eight channels, and controls an amplification adjusting unit and an AGC to enable the selected hearing aid to correspond to the hearing test result 201 of the person with hearing loss.

However, the digital hearing aid fitting system capable of changing the frequency band and channel according to the present invention may change a bandwidth and a number of frequency bands and arbitrarily segment the bandwidth. Accordingly, the digital hearing aid system capable of changing the frequency band and channel may divide the bandwidth of a single digital hearing aid into eight bands 301 and three channels 302 as illustrated in 300 of FIG. 3 or may divide the bandwidth into five bands 401 and two channels 402 as illustrate in 400 of FIG. 4. Also, since the system may arbitrarily divide the bandwidth, a bandwidth may be divided corresponding to the hearing test result 201 of the person with hearing loss even when the person does not use a hearing aid in which a specific bandwidth is segmented, and thus the person with hearing loss may select desired one from among a variety of hearing aids.

An example of the bandwidth divided into eight bands and three channels are illustrated in 300 of FIG. 3 and an example of the bandwidth divided into five bands and two channels are illustrated in 400 of FIG. 4.

FIG. 5 is an example of a screen displayed on a parameter displaying unit 122 according to an example embodiment of the present invention.

As illustrated in FIG. 5, a screen displayed on the parameter displaying unit 122 through a fitting program includes a test result controlling unit 501 to display a hearing test result 201 of a person with hearing loss and to store and delete the displayed hearing test result 201, a left ear result displaying unit 502 to display the hearing test result 201 of a left ear through the test result controlling unit 501, a right ear result displaying unit 502 to display the hearing test result 201 of a right ear through the test result controlling unit 501, a bandwidth adjusting unit 504 to adjust an amplification degree and AGC through determining a band width, and a number of bands and channels selecting unit 505 to select a number of bands and channels appropriate to a characteristic of the hearing loss.

Also, the fitting program may adjust a band gain and an AGC of a channel, perform feedback cancellation and noise cancellation, and display a control inputting unit on the parameter display unit 122.

The digital hearing aid fitting system capable of changing the frequency band and channel according to an example of the present invention may use the same DSP chip regardless of a design and model of a digital hearing aid, and, based on this, use a fitting program in which parameters used for fitting the digital hearing aid are integrated into integrated conventional DSP chips different for each model. Therefore, there is no need to develop the hearing aid for each model, and thus, development costs are reduced, thereby reducing customer price.

Also, the conventional digital hearing aid with a higher price tends to provide various functions and a variety of channels so as to provide high quality of sound. However, if the person with hearing loss does not need the functions, the functions may be wasted. Conversely, the digital hearing aid fitting system capable of changing a frequency band and channel according to an example embodiment may adjust a bandwidth and a number of bands and channels appropriate to a hearing characteristic of the person with hearing loss to use desired functions of a hearing aid. Also, although hearing ability varies while the person with hearing loss uses the hearing aid after fitting, the digital hearing aid fitting system may provide a different compensation effect to the same hearing aid, thereby preventing wastefulness of purchasing of a new hearing aid again.

As described above, according to example embodiments of the present invention, the digital hearing aid fitting system may change a number of frequency bands, a bandwidth, and a number of channels to be appropriate to the hearing of the person with hearing loss, when fitting the digital hearing aid.

Since the conventional hearing aid in which the above three are preset when manufactured, the person with hearing loss selects a hearing aid considering a price and one's hearing ability. In this instance, the hearing aid may compensate for the hearing of the person with hearing loss through the number of frequency bands, bandwidth, and the number of channels respectively preset. For example, typically, a center frequency of the bandwidth of the conventional hearing aid is preset as 250, 500, 1 k, 2 k, 4 k, and 8 k Hz (the number of frequency bands: 6). An inexpensive hearing aid may have four frequency bands and an expensive hearing aid may have a far greater number of frequency bands.

However, according to example embodiments of the present invention, a number of frequency bands, a bandwidth, and a number of channels are not preset, and a single hearing aid may appropriately provide aid according to the hearing loss. For example, according to example embodiments of the present invention, the bandwidth is not preset and the bandwidth is adjusted as 250, 500, 700, 1200, 3000, 4000, 7500 Hz, and the like according to the person who selects the hearing aid. Also, the number of bands may appropriately be selected as four, five, ten, and the like.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A digital hearing aid fitting system capable of changing a frequency band and a channel, the system comprising:
a digital signal processing (DSP) chip to adjust a fitting parameter including at least one parameter from among a number of bands of a frequency, bandwidth, and a number of channels of the frequency; and
a controlling unit to control the DSP chip based on a hearing test result to adjust the fitting parameter to a person with hearing loss.

2. The system of claim 1, wherein a menu provided by a fitting program to adjust the fitting parameter is independent of a digital hearing aid model, the fitting program controlling the DSP chip being stored in the controlling unit controls.

3. The system of claim 2, wherein the fitting program displays selectable examples of the fitting parameter based on the hearing test result to enable the person to select one desired example from among the examples.

4. The system of claim 3, wherein the fitting program controls the DSP chip to adjust the fitting parameter to the fitting parameter selected from among the examples.

5. The system of claim 2, wherein the fitting program selects the fitting parameter appropriate to the person, and controls the DSP chip to adjust the fitting parameter to the selected fitting parameter.

6. A digital hearing aid fitting system capable of changing a frequency band and a channel, the system comprising:
a fitting parameter selecting unit to select fitting parameter appropriate to a person with hearing loss based on a hearing test result;
a parameter displaying unit to display the fitting parameter selected from the fitting parameter selecting unit based on the hearing test result; and
an adjusting unit to control a DSP chip to adjust a fitting parameter to the fitting parameter selected from the fitting parameter selecting unit.

7. The system of claim 6, wherein the fitting parameter includes at least one parameter from among a number of bands of a frequency, a bandwidth, and a number of channels of the frequency.

8. The system of claim 6, wherein the fitting system is composed of programs compatible with all digital hearing aid models, the digital hearing aid models being combined with a DSP chip that adjusts a fitting parameter.

9. The system of claim 6, wherein the fitting parameter selecting unit selects examples of a fitting parameter that are selectable for the person with hearing loss based on the hearing test result, and the parameter displaying unit displays the examples to be selected.

10. The system of claim 9, wherein the adjusting unit controls the DSP chip to adjust the fitting parameter to the selected example, when at least one example is selected from among the examples displayed in the parameter displaying unit.
